(19) United States
(12) Patent Application Publication
(10) Pub. No.: US 2008/0086535 A1
(43) Pub. Date: Apr. 10, 2008

(54) Instant messaging server suitable for notifying the accessibility of information to a client

(75) Inventors: Priscille Arhant-Wibaux, Pont-Pean (FR); Herve Texier, Noyal Chantillon Sur Seiche (FR)

Correspondence Address: COHEN PONTANI LIEBERMAN & PAVANE LLP, 551 Fifth Avenue, Suite 1210, New York, NY, 10176, US

(73) Assignee: France Telecom, Paris (FR)

(21) Appl. No.: 11/973,776

(22) Filed: Oct. 9, 2007

(30) Foreign Application Priority Data
Oct. 9, 2006 (FR) 0654142

(51) Int. Cl. G06F 15/16

(52) U.S. Cl. 709/207

(57) ABSTRACT

This instant messaging server includes: means for receiving a first notification from a first instant messaging client, the first notification representing the availability of information for a second client; means for registering a state of presence associated with the first client representing the fact that the information is available for said second client; and means for sending a second notification to a second instant messaging client, the second notification representing that state of presence in response to any presence enquiry effected by this second client.

### BACKGROUND OF THE INVENTION

The invention relates to an instant messaging server and to a method that can be used in that server.

An instant messaging (IM) service enables users registered for the service to exchange mainly text messages via the Internet using the interface of an instant messaging client provided for this purpose. This is known in the art.

In such mechanisms, each instant messaging client sends its message to an instant messaging server responsible for forwarding the message to the destination instant messaging client.

Also known in the art, in particular from the document WO 02/17101, is a mechanism in which an instant messaging client can consult a remote server using an instant messaging protocol to obtain information accessible to that server.

For example, a client can encapsulate a request for stock market information in an instant message and send the message to a server likely to have that information.

If the server does have the information, it can send the requested information in an instant message to the client that sent the request.

That data server, which behaves like an instant messaging client, is called a “virtual contact”.

Since instant messaging mechanisms were designed for highly-interactive dialogue between two users, it is clear that the aforementioned mechanism for consulting a virtual contact works satisfactorily provided that the virtual contact is able to respond rapidly to the request from the client.

If the virtual contact does not have the required information and must look it up or perform relatively lengthy processing, there can be a long delay between the request sent by the client and the response to that request.

Consequently, that response might be sent to the first client at a time when the first client is not disposed to receive it. In this sense, instant messaging mechanisms with virtual contacts known at present are intrusive.

The present invention is aimed at a new instant messaging mechanism in which information obtained belatedly by an instant messaging client can be sent to another instant messaging client non-intrusively.

### OBJECT AND SUMMARY OF THE INVENTION

A first aspect of the invention consists in an instant messaging server including:
means for receiving a first notification from a first instant messaging client the first notification representing the availability of information for at least one second client;
means for registering a state of presence of the first client representing the fact that the information is available for said at least one second client; and
means for sending a second notification to a second instant messaging client, the second notification representing this state of presence in response to any presence enquiry effected by the second client.

In the context of the present application, a presence enquiry is an event suitable for indicating to the messaging server that the second client wishes to know the availability of the requested information via the state of presence of the first client.

In correlated manner, the invention consists in a method that can be used in an instant messaging server enabling a first instant messaging client to send information non-intrusively to a second instant messaging client. This method comprises:
a step of receiving a first notification from the first instant messaging client, the first notification representing the availability of information for at least one second client;
a step of registering a state of presence associated with that first client representing the fact that the information is available for said at least one second client;
a step of sending a second notification to a second client, the second notification representing that state of presence in response to any presence enquiry effected by the second client.

According to the invention, if the first client has the information requested by the second client, it does not send an instant message directly to the second client in order to supply it with the required information.

In this sense, the method and the server of the invention are not intrusive.

On the contrary, the invention proposes using a presence mechanism to indicate to the second client that the required information is available from the first client.

It is therefore by an intentional action that the second client obtains the information from the first client, at a time when the second client is disposed to do so.

In one particular embodiment of the invention, the state of presence representing the fact that the information is accessible is registered in a presence table.

Note at this point that the messaging server of the invention can also, and independently, maintain in this presence table the state of presence of the various clients of the network.

In one particular embodiment, the presence server of the invention includes:
means for detecting the first client sending an instant message to a second client; and
means for modifying the state of presence after said detection, at least for the second client.

In correlated manner, in one particular implementation, the method includes the following steps:
a step of detecting the first client sending an instant message to a second client; and
a modification step of modifying said state of presence after said detection, at least for this second client.

Of course, the client that receives the instant message can be the client that received the notification indicating that the information was accessible. This is the probable scenario in which the client, having received the notification to the effect that the required information is available, logs onto the server to receive that information in an instant message.

In a different scenario, the client receiving the notification is different from the client receiving the information. This situation can arise in particular if one of these clients does not have the hardware or software resources for receiving the notification or the instant message. Under such circumstances, the client that receives the notification informs another client that information has become available, with that other client being responsible for recovering the information from the server in an instant message.

In one particular embodiment of the invention, the state of presence representing the fact that the information required by a second client is accessible via the first client is permanent.

This means that it remains registered, for example, in the presence table, so long as the first client has not sent an instant message to the second client.

Thus if the second client logs off and logs onto the instant messaging network again several times, the second client obtains in response to any presence enquiry a notification to the effect that the information required from the first client is available.

In one particular embodiment, the instant messaging server of the invention manages two states of presence associated with the first client, namely:
a first state of presence representing the presence of the first client; and
a second state of presence representing the fact that the information requested by the second client is available from the first client.

In this particular embodiment, the messaging server reverts to the first state of presence following detection of the first client sending an instant message to the second client.

In one particular embodiment of the invention, the sending means of the messaging server are adapted to send an error message to the first client on receipt of the first notification if the first client is not authorized to register that state of presence.

Accordingly, this embodiment of the invention assigns rights to an instant messaging client, enabling it to signal or prohibiting it from signaling to the other clients of the network the fact that it has just accessed information.

In one particular embodiment of the invention, the user of an instant messaging client can configure the rights of the instant messaging client to enable it to signal or to prevent it from signaling the availability of the information.

In one particular embodiment of the invention, the receiver means of the instant messaging server are adapted to receive the first notification in accordance with the protocol known as SOAP.

In one particular embodiment of the invention, the sending means of the instant messaging server are adapted to send the second notification in accordance with the protocol known as XMPP.

In one particular embodiment of the invention, the messaging server of the invention includes means for modifying the state of presence on the expiry of a predetermined time-delay running from registration.

This embodiment regularly purges the presence table if a client does not seek this information from the first client within the predetermined time-delay.

In one particular embodiment, the various steps of the method of the invention are determined by computer program instructions.

Consequently, the invention is also directed to a computer program on a data medium, the program being adapted to be executed in an instant messaging server or more generally in a computer, and the program including instructions adapted to execute the steps of the above method.

The program can use any programming language and take the form of source code, object code, or code that is intermediate between source code and object code, such as a partially compiled form, or any other desirable form.

The invention is also directed to a computer-readable data medium including instructions of a computer program as referred to above.

The data medium can be any entity or device capable of storing the program. For example, the medium can include storage means, such as a read-only memory (ROM), for example a CD ROM or a microelectronic circuit ROM, or magnetic storage means, for example a diskette (floppy disk), or a hard disk.

Moreover, the data medium can be a transmissible medium such as an electrical or optical signal, which can be conveyed via an electrical or optical cable, by radio or by other means. The program of the invention can in particular be downloaded over an Internet-type network.

Alternatively, the data medium can be an integrated circuit in which the program is incorporated, the circuit being adapted to execute or to be used in the execution of the method in question.

The invention is also aimed at an instant messaging system including a messaging server as referred to above.

The invention applies in particular when the instant messaging client that notifies that information has been made available is itself a virtual contact.

However, the invention is equally applicable when the instant messaging clients are used by physical people. In this context, it enables a user to send a notification to another user, rather than an intrusive message, thus leaving the other user the opportunity to contact the first user subsequently, and at the other user's convenience, to obtain the information.

### BRIEF DESCRIPTION OF THE DRAWINGS

Other features and advantages of the present invention emerge from the description given below with reference to the appended drawings, which show a non-limiting embodiment thereof. In the figures:

FIG. 1 represents a messaging system in accordance with the invention in one particular embodiment of the invention;

FIGS. 2A to 2D represent presence tables that can be used in the invention; and

FIG. 3 represents, in flowchart form, the principal steps of a method in accordance with the invention in one particular embodiment.

### DETAILED DESCRIPTION OF AN EMBODIMENT

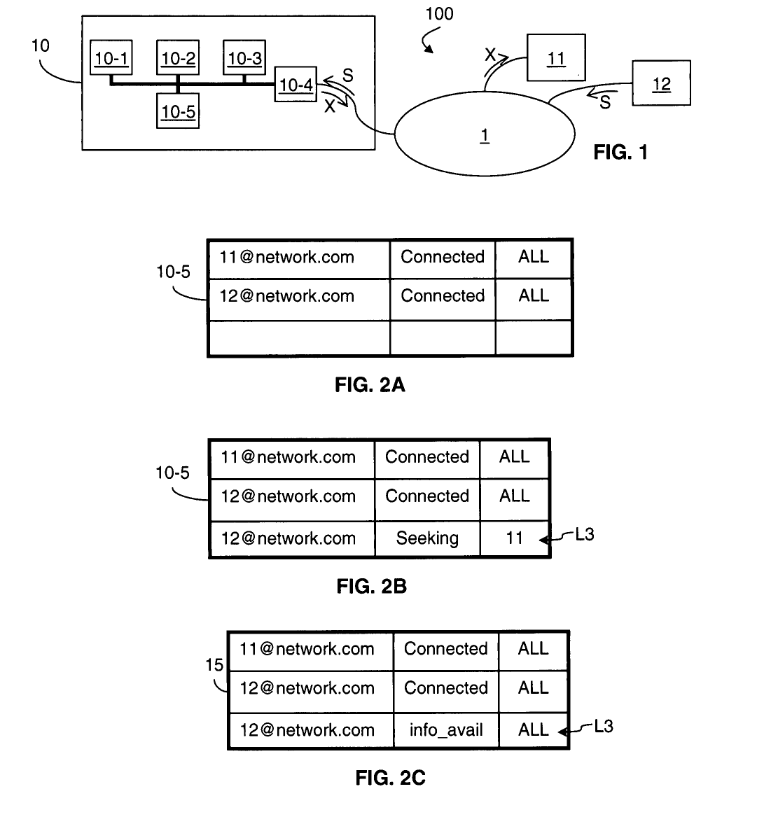

FIG. 1 represents an instant messaging system 100 in accordance with the invention.

The system 100 includes an instant messaging server 10 in accordance with the invention.

In the particular embodiment described here, the messaging server 10 has a standard computer architecture.

It includes in particular a processor 10-1, a random access memory 12, a read-only memory (ROM) 10-3, and means 10-4 for communicating with an Internet Protocol network 1. These communication means include means for receiving data and means for sending data.

In the read-only memory 10-3, which can be read by the processor 10-1, there is stored a computer program comprising instructions for executing a method of the invention as shown in the flowchart of FIG. 3.

In FIG. 1, there are two instant messaging clients, a first client 12 and a second client 11, connected to the Internet Protocol network 1.

It is assumed that these two instant messaging clients 11 and 12 are registered for the instant messaging service with the server 10 in accordance with the invention.

The server 10 includes a presence table 10-5 in which it registers the state of presence of the instant messaging clients on the Internet Protocol network 1. This is known in the art.

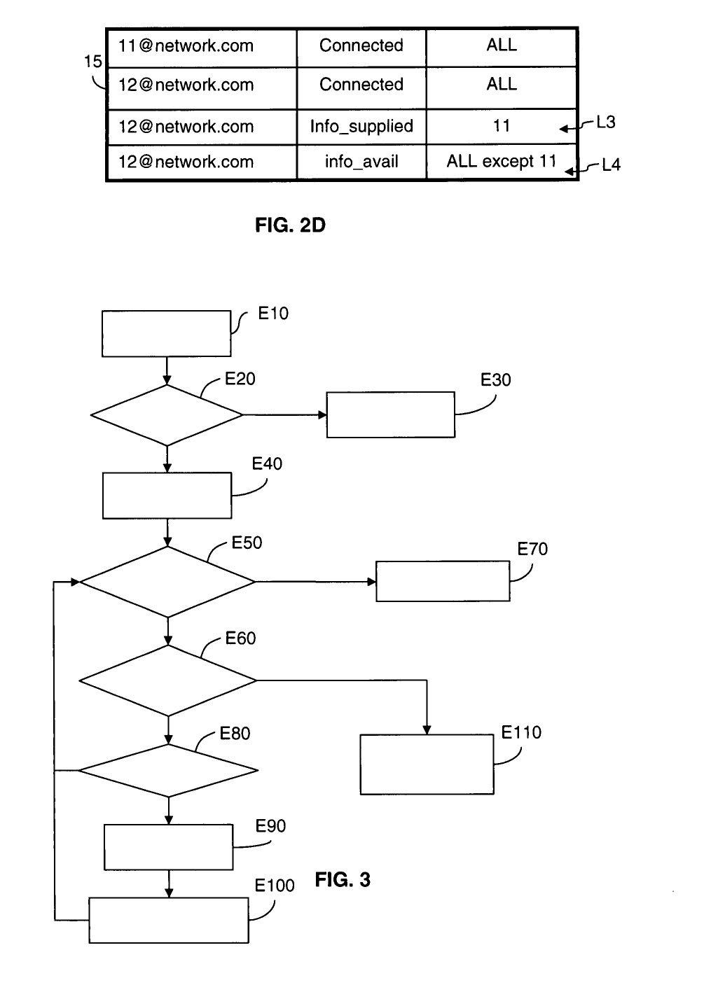

FIG. 2A represents the content of the presence table 10-5 before implementing the invention.

Each of the rows of this presence table comprises three columns.

In the first column is the Internet address of an instant messaging client, in the second column a state of presence of that client, and in the third column a list of the instant messaging clients to which the instant messaging server 10 can communicate this state of presence of this client in response to a presence enquiry.

In the embodiment described here, the server 10 manages four states of presence:
“connected”: representing the fact that the client is connected to the instant messaging service;
“seeking”: representing the fact that the client has received a request for information but that it is not available for the time being;
“info_avail”: representing the fact that the client has information that is available for another client;
“info_supplied”: representing the fact that information available for a client has been supplied to that client.

Thus, in accordance with the first row of the table 10-5 of FIG. 2A, the state of presence of the second client 11, with Internet address 11@network.com, represents the fact that this second client is connected to the instant messaging service is a fact that must be communicated to any instant messaging service in response to a presence enquiry in respect of the second client.

The example described here assumes that the first instant messaging client 12 is a virtual contact, namely a data server.

It also assumes that the second instant messaging client 11 has sent an enquiry, via the instant messaging service, to the virtual contact 12, in order to obtain information.

In practice, this enquiry transits via the instant messaging server 10.

It further assumes that the information requested by the second client 11 cannot be accessed by the virtual contact 12.

In this particular embodiment of the invention, the virtual contact 12 sends a message to the first client 11 via the instant messaging system to inform it that the requested information will be available later.

At the same time, the server 10 of the invention places in a row L3 of the table 10-5 a “seeking” state of presence representing the fact that the first client 12 has received a request for information from the second client 11 but that it is not available for the moment.

This table is represented in FIG. 2B.

At this stage the virtual contact 12 obtains the required information.

In accordance with the invention, the virtual contact 12 sends the instant messaging server 10 of the invention a first notification S representing the availability of this information.

In the example described here, this first notification S is sent in accordance with the protocol known as SOAP.

The method in accordance with the invention as implemented in the instant messaging server 10 is described below with reference to FIG. 3.

During a first step E10, the instant messaging server 10 receives the first notification S sent by the virtual contact 12.

This reception step E10 is followed by a test E20 during which the messaging server 10 verifies whether the virtual contact 12 is authorized to send this first notification S.

If not, the result of the test E20 is negative. This test is then followed by a step E30 during which the messaging server 10 sends an error message to the virtual contact 12.

This example assumes that the virtual contact 12 is authorized to send this first notification to the messaging server 10.

This authorization may take the form of placing specific rights in a configuration table of the virtual contact 12, for example.

Since the virtual contact 12 is authorized to send this first notification, the result of the check test E20 is positive.

That test is then followed by a step E40 during which the messaging server 10 places in the presence table 10-5 an “info_avail” state of presence associated with the virtual contact 12 and representing the fact that the information required by the second client 11 is available from the virtual contact 12.

In the embodiment described here, this “info_avail” state of presence can be communicated to all the instant messaging clients in response to any presence enquiry.

FIG. 2C represents the presence table 10-5 after this state is placed in a row L3.

In this particular embodiment of the invention, the messaging server 10 keeps the “info_avail” state of presence in the presence table 10-5 until the expiry of a predetermined time delay running from its registration therein.

In order to verify whether this condition is satisfied, the messaging server 10 starts a counter after registering the “info_avail” state of presence.

Then, during a test E50, the messaging server 10 checks whether the predetermined time delay has expired.

If it has, the test E50 is followed by a step E70 during which the messaging server 10 deletes the row L3 from the presence table 10-5.

If the time delay has not expired, the messaging server 10 checks during a test E60 whether the virtual contact 12 has sent an instant message to the second instant messaging client 11.

If not, the result of the test E60 is negative. This test E60 is then followed by a test E80 during which the messaging server 10 determines whether a presence enquiry has been effected by the second instant messaging client 11.

If not, the test E80 is followed by the above-described test E50, during which the messaging server 10 determines whether the predetermined delay running from the registration step E40 has expired.

Below, it is assumed that the second instant messaging client 11 has effected a presence enquiry and that the result of the test E80 is positive.

That test E80 is then followed by a step E90 during which the messaging server 10 reads the presence table 10-5 and finds therein the “info_avail” state of presence representing the fact that the information requested by the second instant messaging client is available from the virtual contact 12.

This reading step E90 is followed by a step E100 during which the instant messaging server 10 sends the second instant messaging client 11 a notification representing that state of presence.

In the embodiment described here, that notification X is sent in accordance with the protocol known as XMPP.

Accordingly, the second instant messaging client 11 becomes aware that the information is now available from the virtual contact 12.

It can then send an instant message via the server 10 to the virtual contact 12.

When the virtual contact 12 receives this instant message, it responds to it by sending an instant message containing the requested information.

This instant message is detected by the instant messaging server 10 during the aforementioned test E60, and the result of that test E60 is positive.

The messaging server 10 assumes that this message does indeed include the information requested by the second instant messaging client 11 and, during a step E110, modifies the state of presence of the row L3 of the table 10-5.

In the example described here, this state of presence goes to the value “info_supplied”.

At the same time, the server 10 creates a new row L4 in the table 10-5 in which it places the “info_avail” state of presence for all the messaging clients other than the second client 11.

FIG. 2D represents the presence table 10-5 after this new registration.

In the embodiment described here, the two rows L3 and L4 are deleted on the expiry of the predetermined time delay running from the registration step E50.

In another embodiment, the messaging server 10 in accordance with the invention manages only two states of presence, namely:
a first state of presence representing the fact that the client 12 is connected to the messaging service; and
a second state of presence representing the fact that information is available for the second client 11.

In this particular embodiment, the messaging server 10 reverts to the first state of presence as soon as the virtual client 12 sends an instant message to the second client 11.

What is claimed is:

1. An instant messaging server including:
means for receiving a first notification from a first instant messaging client, the first notification representing the availability of information for at least one second client;
means for registering a state of presence associated with said first client, representing the fact that said information is available for said at least one second client; and
means for sending a second notification to a second instant messaging client, the second notification representing said state of presence in response to any presence enquiry effected by said second client.

2. An instant messaging server according to claim 1, including:
means for detecting said first client sending an instant message to a second client; and
means for modifying said state of presence after said detection, at least for the second client.

3. An instant messaging server according to claim 2, managing two states of presence associated with said first client, namely:
a first state of presence representing the presence of said first client; and
a second state of presence representing the fact that said information is available from the first client.

4. A server according to claim 3, wherein said state of presence reverts to said first state of presence after said detection.

5. A messaging server according to claim 1, wherein said sending means are adapted to send an error message to said first client on reception of said first notification if said first client is not authorized to have said state of presence registered.

6. A messaging server according to claim 1, including means for modifying said state of presence on the expiry of a predetermined time-delay running from said registration.

7. An instant messaging system including a messaging server according to claim 1.

8. An instant messaging system according to claim 7 wherein said first client is a virtual client.

9. A method that can be used in an instant messaging server enabling a first instant messaging client to send information to a second instant messaging client, the method comprising:
a step of receiving a first notification from said first instant messaging client, the first notification representing the availability of information for at least one second client;
a step of registering a state of presence associated with said first client representing the fact that said information is available for said at least one second client;
a step of sending a second notification to a second client, the second notification representing said state of presence in response to any presence enquiry effected by said second client.

10. A method according to claim 9, including the following steps:
a step of detecting said first client sending an instant message to a second client; and
a modification step of modifying said state of presence after said detection, at least for this second client.

11. A computer program including instructions for executing steps of the method according to claim 9 when said program is executed by a computer.

12. A storage medium readable by a computer in which there is stored a computer program including instructions for executing the steps of the method according to claim 9.
